(19) United States
(12) Patent Application Publication
(10) Pub. No.: US 2023/0419643 A1
(43) Pub. Date: Dec. 28, 2023

(54) MACHINE LEARNING DEVICE AND MACHINE LEARNING METHOD

(71) Applicant: FANUC CORPORATION, Minamitsuru-gun, Yamanashi (JP)

(72) Inventor: Weijia LI, Yamanashi (JP)

(21) Appl. No.: 18/038,832

(22) PCT Filed: Dec. 20, 2021
(86) PCT No.: PCT/JP2021/046971

§ 371 Date: May 25, 2023

(30) Foreign Application Priority Data
Dec. 25, 2020 (JP) 2020-216583

(51) Int. Cl. G06V 10/776; G06V 10/70; G06V 10/77

(52) U.S. Cl. CPC G06V 10/776; G06V 10/87; G06V 10/7715

(57) ABSTRACT

Good performance is obtained even with a small amount of training data, by reducing time and labor required for collecting training data for use in training. This machine learning device has an acquisition unit that acquires inference data and training data for use in machine learning, a training unit that performs machine learning based on the training data and sets of training parameters and generates trained models, a model assessment unit assesses whether or not the trained results by the trained models are good and displays the assessment results, a model selection unit that can receive a selected trained model, an inference calculation unit that performs inference calculation processing based on at least a part of the trained models and the inference data and generates inference result candidates, and an inference determination unit that outputs at least part of the inference result candidates or the combinations thereof.

### TECHNICAL FIELD

The present invention relates to a machine learning device and a machine learning method.

### BACKGROUND ART

Recently, machine learning has been widely applied in various fields. In a supervised learning algorithm, a trained model (for example, a classifier for a classification problem or a neural network) is generated by performing training using training data, and even an unlearned case is inferred using the generated trained model. Here, it is difficult to generate a trained model with a good performance.

As one solution method, variation of training data is increased to perform training. For example, there is proposed a technology of performing ensemble training based on a plurality of trained models generated using a plurality of pieces of training data to detect various objects. See, for example, Patent Document 1.
Patent Document 1: Japanese Unexamined Patent Application, Publication No. 2020-77231

### DISCLOSURE OF THE INVENTION

### Problems to be Solved by the Invention

As a second solution method, a long time is spent for devising so that various training parameters (hereinafter also referred to as “hyper parameters”) included in a trained model are adjusted well. However, the following three problems exist.
(1) The method of increasing variation of training data to perform training has limitations. There may be a case where, even if the variation is increased, training cannot be performed well, and it takes much time and effort to collect a large quantity of training data.
(2) It is difficult to adjust various training parameters (hyper parameters) included in a trained model. There is a problem that, even though much time is spent for the adjustment, a good performance is not obtained.
(3) In the technical field of image recognition, there is a problem that, as a result of inference using a trained model generated by training using training image data, a workpiece in an inference image is not detected, and the workpiece is left at the time of picking out workpieces, so that production efficiency decreases.

Therefore, it is desired to reduce time and effort required to collect training data for use for training, and obtain a good performance even with a small amount of training data.

### Means for Solving the Problems

One aspect of a machine learning device of the present disclosure is a machine learning device comprising: an acquisition unit configured to acquire training data and inference data for use for machine learning; a training unit configured to perform machine learning based on the training data and a plurality of sets of training parameters, and generate a plurality of trained models; a model evaluation unit configured to evaluate whether trained results of the plurality of trained models are good or bad and displaying evaluated results; a model selection unit capable of accepting selection of a trained model; an inference calculation unit configured to perform an inference calculation process based on at least a part of the plurality of trained models, and the inference data, generate inference result candidates; and an inference decision unit configured to output all, or a part, or a combination of the inference result candidates.

A machine learning method of the present disclosure is a machine learning method executed by a computer, the machine learning method comprising: an acquisition step of acquiring training data and inference data for use for machine learning; a training step of performing machine learning based on the training data and a plurality of sets of training parameters, and generating a plurality of trained models; a model evaluation step of evaluating whether trained results of the plurality of trained models are good or bad and displaying evaluated results; a model selection step of enabling acceptance of selection of a trained model; an inference calculation step of performing an inference calculation process based on at least a part of the plurality of trained models, and the inference data, generating inference result candidates; and an inference decision step of outputting all, or a part, or a combination of the inference result candidates.

### Effects of the Invention

According to one aspect, it is possible to reduce time and effort required to collect training data for use for training, and obtain a good performance with a small amount of training data.

### BRIEF DESCRIPTION OF THE DRAWINGS

FIG. 1 is a diagram showing an example of a configuration of a robot system according to one embodiment;

FIG. 2 is a functional block diagram showing a functional configuration example of a robot control device according to the one embodiment;

FIG. 3 is a functional block diagram showing a functional configuration example of a machine learning device according to the one embodiment;

FIG. 4 is a flowchart illustrating a machine learning process of the machine learning device on a training phase; and

FIG. 5 is a flowchart illustrating an inference calculation process of the machine learning device on an operational phase.

### PREFERRED MODE FOR CARRYING OUT THE INVENTION

### One Embodiment

A configuration of the present embodiment will be described in detail using drawings.

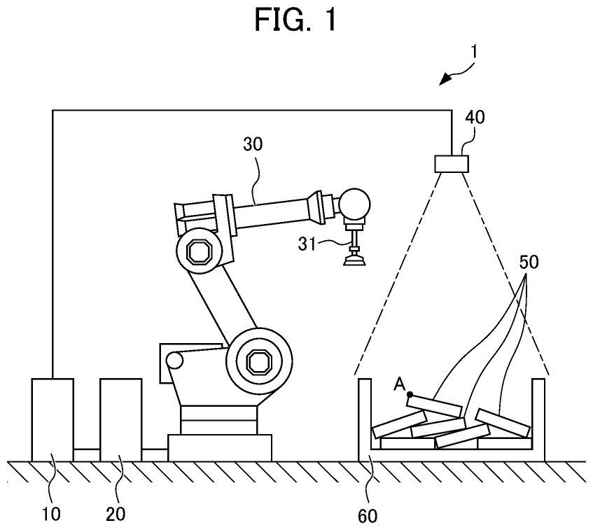

FIG. 1 is a diagram showing an example of a configuration of a robot system 1 according to one embodiment.

As shown in FIG. 1, the robot system 1 has a machine learning device 10, a robot control device 20, a robot 30, a measuring instrument 40, a plurality of workpieces 50, and a container 60.

The machine learning device 10, the robot control device 20, the robot 30, and the measuring instrument 40 may be mutually directly connected via connection interfaces not shown. The machine learning device 10, the robot control device 20, the robot 30, and the measuring instrument 40 may be mutually connected via a network not shown, such as a LAN (local area network) or the Internet. In this case, the machine learning device 10, the robot control device 20, the robot 30, and the measuring instrument 40 are provided with communication units not shown for mutually performing communication by such connection as above. In FIG. 1, the machine learning device 10 and the robot control device 20 are shown being independent of each other to make it easy to make description, and the machine learning device 10 in that case may be configured, for example, with a computer. The present invention is not limited to such a configuration, and, for example, the machine learning device 10 may be implemented inside the robot control device 20 and integrated with the robot control device 20.

### <Robot Control Device 20>

The robot control device 20 is a device for controlling motions of the robot 30, which is well known to one skilled in the art. For example, the robot control device 20 receives picking position information about a workpiece 50 selected by the machine learning device 10 described later from among the workpieces 50 piled up in bulk, from the machine learning device 10. The robot control device 20 generates a control signal for controlling motions of the robot 30 to pick out the workpiece 50 existing at the picking position received from the machine learning device 10. Then, the robot control device 20 outputs the generated control signal to the robot 30. Further, the robot control device 20 outputs an execution result of a picking motion by the robot 30, to the machine learning device 10.

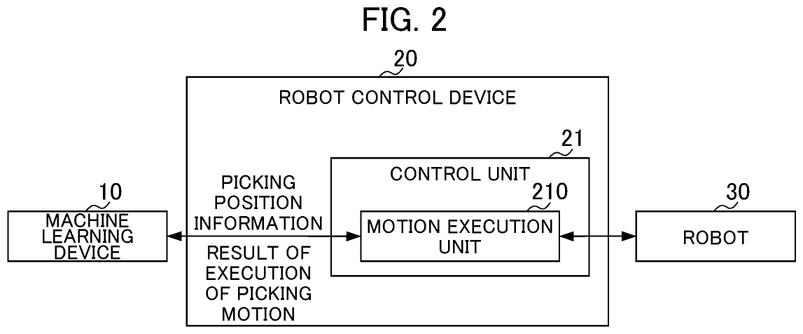

FIG. 2 is a functional block diagram showing a functional configuration example of the robot control device 20 according to the one embodiment.

The robot control device 20 is a computer that is well known to one skilled in the art, and includes a control unit 21 as shown in FIG. 2. The control unit 21 includes a motion execution unit 210.

### <Control Unit 21>

The control unit 21 includes a CPU (central processing unit), a ROM, a RAM (random access memory), and a CMOS (complementary metal-oxide-semiconductor) memory, and the like. These are configured to be mutually communicable via a bus and are well known to one skilled in the art.

The CPU is a processor that performs overall control of the robot control device 20. The CPU reads out a system program and an application program stored in the ROM via the bus, and performs overall control of the robot control device 20 according to the system program and the application program. Thereby, the control unit 21 is configured to realize functions of the motion execution unit 210 as shown in FIG. 2. In the RAM, various kinds of data such as temporary calculation data and display data are stored. The CMOS memory is backed up by a battery not shown and is configured as a nonvolatile memory in which a stored state is kept even if the robot control device 20 is powered off.

### <Motion Execution Unit 210>

The motion execution unit 210 controls a take-out hand 31 of the robot 30 described later to pick out a workpiece 50 by the take-out hand 31, based on a picking position inference result outputted by the machine learning device 10 described later. The motion execution unit 210 may feed back information indicating whether picking out of the workpiece 50 by the take-out hand 31 is successful or not to the machine learning device 10 as a picking motion execution result, for example, based on a signal from a sensor installed on the take-out hand 31.

The robot control device 20 may include the machine learning device 10 as described later.

The robot 30 is a robot that performs a motion based on control by the robot control device 20. The robot 30 is provided with a base portion to rotate around an axis in a vertical direction, an arm that moves and rotates, and the take-out hand 31 fitted to the arm to hold a workpiece 50.

Specifically, the take-out hand 31 may be in an arbitrary configuration capable of holding one workpiece 50 at a time. For example, the take-out hand 31 may be configured to have an adsorption pad for adsorbing a workpiece 50. Thus, the take-out hand 31 may be an adsorption-type hand that adsorbs a workpiece 50 utilizing air tightness but may be a suction-type hand with a strong suction power, which does not require air-tightness. Further the take-out hand 31 may be configured as a grasp-type hand with a pair of, or three or more grasping fingers to grasp and hold the workpiece 50 or may be configured having a plurality of adsorption pads. Or alternatively, the take-out hand 31 may be configured to have such a magnetic hand that magnetically holds a workpiece 50 made of iron or the like.

When the take-out hand 31 is, for example, an air suction type hand, the take-out hand 31 may be implemented with a sensor that detects a change in the air pressure inside the hand between the time of holding a workpiece 50 and the time of not holding a workpiece 50. Further, when the take-out hand 31 is a grasping type hand, the take-out hand 31 may be implemented with a contact sensor, a force sensor, or the like that detects whether a workpiece is held or not, and may be implemented with a position sensor that detects positions of the grasping fingers performing a motion. When the take-out hand 31 is a magnetic hand, the take-out hand 31 may be implemented with a permanent magnet inside the hand and may be implemented with a position sensor that detects the position thereof.

The robot 30 drives the arm and the take-out hand 31 in response to a control signal outputted by the robot control device 20, causes the take-out hand 31 to move to a picking position selected by the machine learning device 10, and holds and picks out each of the workpieces 50 piled up in bulk from the container 60. In this case, the motion execution unit 210 of the robot control device 20 may automatically collect information whether the picking out of the workpiece 50 is successful or not, as an execution result of the picking motion, based on a signal from the sensor implemented in the take-out hand 31, and feed back the collected execution result to the machine learning device 10.

A transfer destination of the taken-out workpiece 50 is not shown. Further, since the specific configuration of the robot 30 is well known to one skilled in the art, details thereof will be omitted.

It is assumed that, in the machine learning device 10 and the robot control device 20, a machine coordinate system for controlling the robot 30 and a coordinate system of the measuring instrument 40 described later, which shows a position of picking out a workpiece 50 are associated by calibration performed in advance.

The measuring instrument 40 is configured, for example, to include a camera sensor and the like. The measuring instrument 40 may capture a visible light image, such as an RGB color image, a gray scale image, or a depth image of two-dimensional image data obtained by projecting the workpieces 50 piled up in bulk in the container 60 to a plane vertical to an optical axis of the measuring instrument 40. Further, the measuring instrument 40 may be configured to include an infrared sensor to capture a thermal image or may be configured to include a UV sensor and capture a UV image for inspection of scratches, spots and the like on the surface of an object. Further, the measuring instrument 40 may be configured to include an x-ray camera sensor to capture an x-ray image or may be configured to include an ultrasonic sensor to capture an ultrasonic image.

The measuring instrument 40 may be a three-dimensional measuring instrument and may be configured to acquire three-dimensional information with pixel values, which are values converted from distances between a plane vertical to an optical axis of the three-dimensional measuring instrument and points on the surface of the workpieces 50 piled up in bulk in the container 60 (hereinafter also referred to as a “distance image”). For example, as shown in FIG. 1, the pixel value of a point A on the workpieces 50 on a distance image is obtained by converting from a distance between the measuring instrument 40 and the point A on the workpieces 50 (a height from the measuring instrument 40) in a Z axis direction in a three-dimensional coordinate system (X,Y,Z) of the measuring instrument 40. That is, the Z-axis direction of the three-dimensional coordinate system is a direction of the optical axis of the measuring instrument 40. The measuring instrument 40 may be configured, for example, with a stereo camera, one camera fixed to the hand tip or a moving device of the robot 30, or a combination of one camera and a distance sensor such as a laser scanner or a sonic sensor, and may acquire three-dimensional point cloud data of the plurality of workpieces 50 loaded in the container 60. The three-dimensional point cloud data acquired as described above can be displayed in a 3D view that can be confirmed from every viewpoint in three-dimensional space, and it is discretized data from which a state of the plurality of workpieces 50 loaded on the container 60 being piled can be three-dimensionally confirmed.

The workpieces 50 are placed in a disordered state, including a state of being piled up in bulk in the container 60. A workpiece 50 may be anything that can be held by the take-out hand 31 fitted to the arm of the robot 30, and the shape and the like thereof are not especially limited.

### <Machine Learning Device 10>

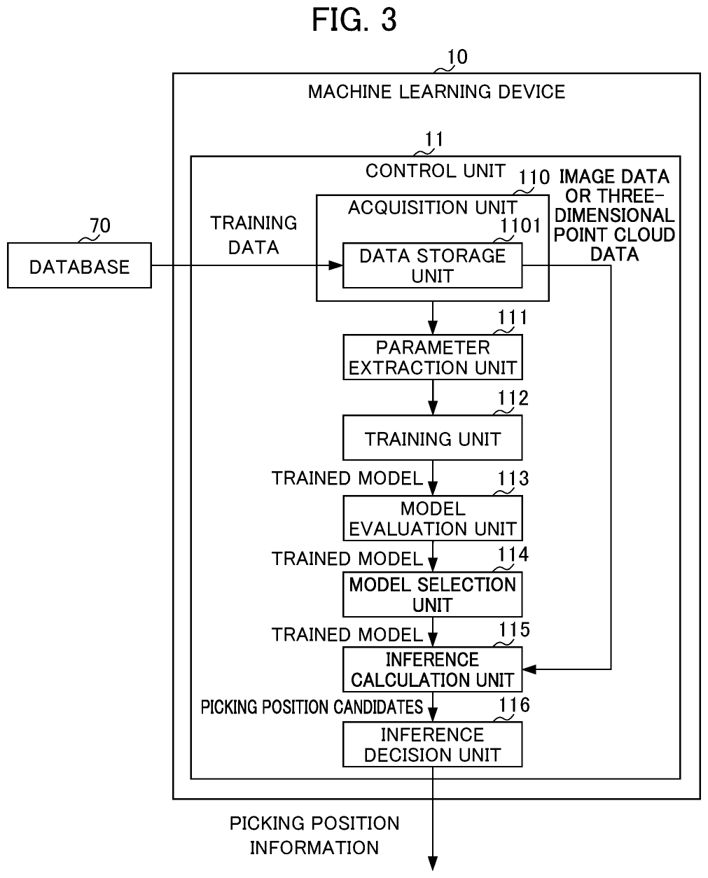

FIG. 3 is a functional block diagram showing a functional configuration example of the machine learning device 10 according to the one embodiment.

The machine learning device 10 may be a computer that is well known to one skilled in the art, and includes a control unit 11 as shown in FIG. 3. The control unit 11 includes an acquisition unit 110, a parameter extraction unit 111, a training unit 112, a model evaluation unit 113, a model selection unit 114, an inference calculation unit 115, and an inference decision unit 116. The acquisition unit 110 includes a data storage unit 1101.

### <Control Unit 11>

The control unit 11 includes a CPU, a ROM, a RAM, a CMOS memory, and the like, and these are configured to be mutually communicable via a bus and are well known to one skilled in the art.

The CPU is a processor that performs overall control of the machine learning device 10. The CPU reads out a system program and an application program stored in the ROM via the bus, and performs overall control of the machine learning device 10 according to the system program and the application program. Thereby, as shown in FIG. 3, the control unit 11 is configured to realize functions of the acquisition unit 110, the parameter extraction unit 111, the training unit 112, the model evaluation unit 113, the model selection unit 114, the inference calculation unit 115, and the inference decision unit 116. The acquisition unit 110 is configured to realize functions of a data storage unit 1101. In the RAM, various kinds of data such as temporary calculation data and display data are stored. The CMOS memory is backed up by a battery not shown and is configured as a nonvolatile memory in which a storage state is kept even if the machine learning device 10 is powered off.

### <Acquisition Unit 110>

The acquisition unit 110 may be configured to include the data storage unit 1101, and may be configured to acquire training data for use for machine learning from a database 70 on a cloud or an edge device and store the training data into the data storage unit 1101. For example, the acquisition unit 110 acquires training data recorded in a recording medium, such as an HDD (hard disk drive) or a USB (universal serial bus) memory, from the database 70 on the cloud or the edge device, via a network such as a LAN, and copies and stores the training data to a recording medium (the data storage unit 1101), such as an HDD or a USB memory, of the machine learning device 10.

Further, the acquisition unit 110 may be configured to acquire inference data for use for machine learning from the measuring instrument 40 and store the inference data into the data storage unit 1101. The inference data may be image data, or may be three-dimensional point cloud data as three-dimensional measurement data or distance images.

### <Parameter Extraction Unit 111>

The parameter extraction unit 111 may be configured to extract important hyper parameters and the like from among all of hyper parameters and the like.

Specifically, the parameter extraction unit 111 can define and evaluate, for example, a degree of contribution to trained performance, and extract hyper parameters and the like with high contribution degrees as the important hyper parameters and the like. For example, a loss function is for evaluating a difference between a prediction result by a trained model and teacher data, and a better performance is obtained as a loss is smaller. Therefore, hyper parameters in the loss function can be extracted as the important hyper parameters, by setting degrees of contribution of the hyper parameters higher than degrees of hyper parameters such as a learning rate and a batch size.

Further, the parameter extraction unit 111 may be adapted to check independence of each of various kinds of hyper parameters and extract independent hyper parameters that are not mutually dependent, as the important hyper parameters.

The parameter extraction unit 111 may be configured to, for a plurality of hyper parameters to which contribution degrees have been given by the above method, decrease the number of the hyper parameters stage by stage at the time of performing machine learning.

Specifically, for example, at the time of performing machine learning, when the model evaluation unit 113 described later evaluates whether a trained model is good or not online and judges that an output value and a loss predicted by the trained model have almost converged, the parameter extraction unit 111 may judge that optimal values of a learning rate and a training epoch have been found and, after that, pay attention only to remaining important hyper parameters to decrease the number of kinds of hyper parameters to be adjusted, stage by stage.

### <Training Unit 112>

The training unit 112 may be configured to, based on training data acquired by the acquisition unit 110, set hyper parameters and the like, and perform machine learning to generate a plurality of trained models. Here, the training unit 112 may generate the plurality of trained models by setting, for one set of training data, a plurality of sets of hyper parameters and the like for a plurality of times and performing machine learning the plurality of times. Further, the training unit 112 may generate the plurality of trained models by setting, for each of a plurality of sets of training data, a plurality of sets of hyper parameters and the like for a plurality of times and performing machine learning the plurality of times.

In the case of supervised learning, training data for use for the training may be configured with training input data and output data (teacher label data). A trained model may be configured with a mapping function for mapping from training input data to output data (teacher label data), and hyper parameters and the like may be configured with various kinds of parameters included in the mapping function. Further, a trained model may be configured with a classifier (for example, an SVM (support vector machine) for a classification problem of performing classification from such training input data that classification labels (teacher label data) are already known, and hyper parameters and the like may be configured with parameters and the like in a loss function defined to solve the classification problem. Or alternatively, a trained model may be configured with a neural network or the like that calculates a predicted value of output data from training input data, and hyper parameters and the like may be configured with the number of layers, the number of units, a learning rate, a batch size, a training epoch, and the like of the neural network.

In the case of unsupervised learning, training data for use for the training may be configured with training input data. A trained model is configured, for example, with a classifier for a classification problem of performing classification from such training input data that classification labels are unknown (for example, a k-means clustering method), and hyper parameters and the like may be configured with parameters and the like in a loss function defined to solve the classification problem.

When training input data is image data, training data may be configured to include the image data and position teaching data (teacher label data) of workpiece picking positions shown in the image data, and a trained model may be configured with a CNN (convolutional neural network). Such a CNN structure may be configured to include, for example, a three-dimensional (or two-dimensional) convolution layer, a batch normalization layer for keeping normalization of data, an activation function ReLu layer, and the like.

When training input data is three-dimensional point cloud data (or distance image data), training data may be configured to include position teaching data (teacher label data) of workpiece picking positions on the three-dimensional point cloud data (or the distance image data), and a trained model may be configured with a CNN. Such a CNN structure may be configured to include, for example, a three-dimensional (or two-dimensional) convolution layer, a batch normalization layer for keeping normalization of data, an activation function ReLu layer, and the like.

When a trained model has the CNN structure described before, it is possible for the training unit 112 to, by setting, for example, the number of layers of the CNN, the number of units, the filter size of a convolution layer, a learning rate, a batch size, and a training epoch to predetermined values once, as one set of hyper parameters and the like and performing machine learning with one set of training data as training input data, generate one trained model (hereinafter also referred to as a “trained model M1”), the trained model M1 being good at identification of macroscopic characteristics on an image (for example, a more larger plane).

Specifically, for example, when training data includes image data and position teaching data of workpiece picking positions shown in the image data, the training unit 112 can substitute one set of image data into the CNN, which is a trained model, to calculate and output a predicted value of a workpiece picking position by the CNN. By performing machine learning, the training unit 112 can generate one such trained model that can, using backpropagation so that a difference between the outputted predicted value of the work picking position and the position teaching data, which is teacher label data, gradually becomes small, output a predicted value close to the position teaching data.

Further, by setting, for each of a plurality of sets of training data, a plurality of sets of hyper parameters and the like for a plurality of times and performing such machine learning as described before the plurality of times, the training unit 112 can generate a plurality of trained models. The plurality of sets of training data to be used are independent pieces of data that are not mutually dependent on, and the plurality of sets of hyper parameters and the like are independent pieces of data that are not mutually dependent on. Therefore, at the time of performing such machine learning as described before the plurality of times, the training unit 112 can perform the machine learning in parallel to shorten total training time.

When a trained model has the CNN structure described before, it is also possible for the training unit 112 to, by setting, for example, the number of layers of the CNN, the number of units, the filter size of a convolution layer, a learning rate, a batch size, and a training epoch to values different from the values set in the case of the trained model M1 once again, as another set of hyper parameters and the like, and performing machine learning once again with one set of training data as training input data, generate another trained model (hereinafter also referred to as a “trained model M2”), the trained model M2 being good at identification of microscopic characteristics on an image (for example, workpiece texture showing material).

Thus, by comprehensively using the plurality of biased trained models M1 and M2 generated using the plurality of sets of biased hyper parameters set for the trained models M1 and M2, it is possible to obtain, for example, such an overall good performance that, while the center of a larger plane on an image is estimated as a workpiece picking position, a workpiece material is simultaneously estimated.

The training unit 112 may be configured to include a GPU (graphics processing unit) and a recording medium such as an HDD or an SSD (solid state drive) and configured to, by introducing training data and a trained model into the GPU, perform machine learning operation (for example, the backpropagation operation described before) at a high speed, generate a plurality of trained models, and store the plurality of trained models into the recording medium such as an HDD or an SSD.

### <Model Evaluation Unit 113>

The model evaluation unit 113 may be configured to evaluate whether trained results of a plurality of trained models generated by the training unit 112 are good or bad and display evaluated results.

Specifically, the model evaluation unit 113 may define, for example, average precision (hereinafter also referred to as “AP”) as an evaluation function, calculate an AP for test data that has not been used for training, evaluate a trained result of a trained model with an AP exceeding a threshold decided in advance as “good”, and record the calculated AP value as an evaluation value of the trained model.

The model evaluation unit 113 may be configured to display the above-described evaluated results for the plurality of trained models, that is, “good” or “bad”, and evaluation values such as APs, on a monitor, a tablet, or the like as a display unit (not shown) included in the machine learning device 10 to present the evaluated results and the evaluation values to a user. The model evaluation unit 113 may numerically or graphically display the evaluation values.

Further, the model evaluation unit 113 may be configured to, based on result information about whether motions of picking out workpieces 50 by the motion execution unit 210 of the robot control device 20 are successful or not as described above, evaluate whether the plurality of trained models generated by the training unit 112 are good or bad. For example, the model evaluation unit 113 may use the result information showing whether picking motions are successful or not, which has been collected from the motion execution unit 210, to evaluate trained models having predicted inference result candidates with high picking success rates as “good” and evaluate trained models having predicted inference result candidates with low picking success rates as “bad”. Furthermore, the model evaluation unit 113 may give an evaluation value indicating the degree of goodness of a trained model in proportion to the value of the picking success rate.

### <Model Selection Unit 114>

The model selection unit 114 may be configured to accept selection of a trained model.

For example, the model selection unit 114 may be configured to accept and record a trained model selected by the user from among a plurality of trained models, via a keyboard and a mouse, or a touch panel as an input unit (not shown) included in the machine learning device 10. The model selection unit 114 may accept selection of one trained model, or two or more trained models.

By the user confirming evaluated results of a plurality of trained models by the model evaluation unit 113, which are displayed on the display unit described above, the model selection unit 114 may, when accepting selection of one or more trained models that have obtained high evaluation values as being “good”, via the input unit (not shown) of the machine learning device 10, accept and record the selection result including the selected one or more trained models

The model selection unit 114 may be configured to automatically select at least one from among the plurality of trained models, based on the evaluated results calculated by the model evaluation unit 113.

For example, the model selection unit 114 may automatically select a trained model with the highest evaluation value from among the plurality of trained models evaluated as “good” by the model evaluation unit 113 or may automatically select all of trained models the evaluation values of which are above a threshold specified in advance.

Further, the model selection unit 114 may be configured to select at least one from among a plurality of trained models generated by the training unit 112, based on the above-described result information showing whether motions of picking out workpieces 50 by the motion execution unit 210 of the robot control device 20 are successful or not. For example, the model selection unit 114 may select, based on the picking success rates described above, a trained model with the highest success rate to use the trained model next time, or may select a plurality of trained models in descending order of the success rate as necessary to switchingly use the plurality of trained models.

### <Inference Calculation Unit 115>

The inference calculation unit 115 may be configured to perform an inference calculation process to generate inference result candidates, based on inference data acquired by the acquisition unit 110 and at least a part of a plurality of trained models generated by the training unit 112.

Description will be made, for example, on a case where training data is configured with image data obtained by photographing an area where a plurality of workpieces 50 are present and position teaching data of workpiece picking positions shown in the image data, and the training unit 112 performs machine learning using such training data to generate a trained model with the CNN structure described above. In this case, the inference calculation unit 115 can substitute inference image data into the CNN as input data, which is a trained model, calculate a predicted position list of picking positions for the workpieces 50 shown on the inference image, and output the predicted position list as inference result candidates. In the case of performing the inference calculation process using a plurality of trained models, for example, m trained models CNN1 to CNNm, the inference calculation unit 115 can generate m predicted position lists 1 to m of the picking positions for the workpieces 50 shown on the inference image (m is an integer equal to or larger than 1). The inference calculation unit 115 may be configured to include a data storage unit (not shown) and configured to store the m predicted position lists 1 to m of the picking positions for the workpieces 50, which are the calculated inference result candidates.

The model evaluation unit 113 may be configured to evaluate whether a plurality of trained models generated by the training unit 112 are good or not, using the inference result candidates by the inference calculation unit 115, and the model selection unit 114 may be configured to select at least one trained model from among the plurality of trained models that have been evaluated.

Specifically, for example, in the case of predicting, from the above-described inference image data obtained by photographing an area where a plurality of workpieces 50 are present, picking position of the workpiece 50 shown in the image, by the inference calculation process, the inference calculation unit 115 can calculate predicted position lists of picking positions for the workpieces 50 shown on the inference image and output the predicted position lists as inference result candidates. In the case of performing the inference calculation process using a plurality of trained models, for example, CNN1 to CNNm, the inference calculation unit 115 generates and outputs m predicted position lists 1 to m.

The model evaluation unit 113 may give high evaluation values to trained models corresponding to lists with a large number of picking position candidates, among the predicted position lists 1 to m, and evaluate the trained models as “good”, and may give low evaluation values to trained models corresponding to lists with a small number of picking position candidates and evaluate the trained models as “bad”.

The model selection unit 114 may, from among the predicted position lists 1 to m, select a trained model corresponding to a list with the largest number of picking position candidates, but may select a plurality of trained models corresponding to a necessary number of lists in descending order of the number of candidates so as to reach a total number specified in advance. Thereby, the machine learning device 10 can predict more picking position candidates for one inference image captured by one photographing, pick out more workpieces 50 by one picking motion, and increase the efficiency of picking out workpieces 50.

The inference calculation unit 115 may be configured to perform the inference calculation process by substituting inference data, using trained models evaluated as “good” by the model evaluation unit 113, to generate the inference result candidates.

By doing so, since it is not possible to obtain good inference result candidates even if the inference calculation process is performed using a “bad” trained model generated without being able to perform training well, the machine learning device 10 can eliminate such useless inference calculation process time and increase the efficiency of the inference calculation process.

### <Inference Decision Unit 116>

The inference decision unit 116 may be configured to output all, a part, or a combination of inference result candidates calculated by the inference calculation unit 115.

For example, when the inference calculation unit 115 has generated the above-described predicted position lists 1 to m for picking positions of the workpieces 50 on the inference image as inference result candidates, the inference decision unit 116 may combine pieces of information about predicted positions included in all the m predicted position lists 1 to m to generate and output the combination as one position list 100. Further, the inference decision unit 116 may combine pieces of predicted position information included in a plurality of list, which is a part of the above lists 1 to m, for example, predicted position lists 1 and 3 to generate and output the combination as one position list 100. Further, the inference decision unit 116 may output a predicted position list with the largest number of predicted positions (for example, a predicted position list 2) as one position list 100.

Thereby, it becomes possible for the machine learning device 10 to, by combining, for one inference image acquired by one measurement, predicted position lists 1 to m predicted by a plurality of biased trained models (CNN1 to CNNm), output more picking position candidates by one measurement, pick out more workpieces 50 by one picking motion, and increase the efficiency of picking out workpieces 50.

Even when adjustment cannot be performed well because the number of hyper parameters and the like is too large, the machine learning device 10 can perform machine learning a plurality of times using a plurality of sets of hyper parameters and the like, and obtain an overall good performance using a plurality of trained models generated.

As an example, an application will be described, the application realizing a task of continuously picking out a plurality of workpieces 50 using machine learning, utilizing an image obtained by photographing of or three-dimensional measurement data of an area where the plurality of workpieces 50 are present in the container 60. There is a task of, using training data teaching a plurality of picking positions on the workpieces 50 in a complicated shape and teaching, for example, picking positions A1, A2, A3, and the like on workpieces 50 of A Type, training the picking positions for the workpieces 50 of A Type and performing inference. There is also a task of, using training data teaching, in a situation of various types of workpieces being mixed, picking positions for workpieces 50 of the various types of workpieces 50, for example, a picking position B1 on workpieces 50 of B Type, a picking position C1 on workpieces 50 of C Type, and picking positions D1 and D2 on workpieces 50 of D Type, training the picking positions of workpieces 50 of each type and performing inference.

In such complicated tasks, no matter how a large number of hyper parameters and the like are adjusted to perform training, a generated trained model is biased, and, therefore, it is difficult to obtain an overall good performance by one trained model. For example, there may be a case where, though the picking position A1 on the workpieces 50 of A Type can be inferred and predicted well, the picking position A2 on the workpieces 50 of A Type cannot be inferred and predicted well, using one trained model. Further, there may also be a case where, though the picking position B1 on the workpieces 50 of B Type can be inferred and predicted well, the picking position C1 on the workpieces 50 of C Type cannot be inferred and predicted well, using one trained model.

If the workpieces 50 are taken out based on inference results obtained by performing inference utilizing one such biased trained model as described above, it is not possible to pick out all the workpieces 50 in the container 60, and a part of the workpieces 50 for which inference and prediction has not been performed well are left behind. The production efficiency decreases.

Here, description will be made on a method of obtaining an overall good performance by utilizing a plurality of biased trained model which have been generated (for example, CNN1 to CNNm) well.

By performing training utilizing a plurality of sets of hyper parameters and the like a plurality of times, the machine learning device 10 generates, for example, a trained model CNN1 that is good at inference/prediction of the picking position B1 on the workpieces 50 of B Type and the picking position C1 on the workpieces 50 of C Type but is not good at inference/prediction of picking positions on workpieces 50 of other types, and also generates a trained model CNN2 that is good at inference/prediction of the picking positions D1 and D2 on the workpieces 50 of D Type but is not good at inference/prediction of picking positions on workpieces 50 of other types. Thereby, by combining pieces of picking position information that the trained models CNN1 and CNN2 have inferred and predicted, respectively, for one piece of inference image data obtained by photographing the inside of the container 60 in which the workpieces 50 of the three types B, C, and D are mixed, the machine learning device 10 can obtain inference results predicting all the picking positions B1 to D2 of all of workpieces 50 of B to D Types. Thereby, the machine learning device 10 can improve the problem of not detecting or leaving behind a part of workpieces 50 and obtain an overall good performance.

As workpieces 50 are taken out, the number of workpieces 50 in the container 60 decreases, and there may be a case where, for example, the workpieces 50 of D Type are not on a captured image. According to such an actual situation, the machine learning device 10 may select and switch to the trained model CNN1 that is good at inference/prediction of the picking positions of B and C Types to perform inference.

A configuration may be made so that, when there is no output from the inference decision unit 116, the model selection unit 114 newly selects at least one trained model from a plurality of trained models, the inference calculation unit 115 performs the inference calculation process based on the newly selected trained model, and the inference decision unit 116 outputs new inference result candidates.

By doing so, even when there is no picking position prediction information in the predicted position lists described above, the machine learning device 10 can realize a continuous picking motion by newly selecting a trained model and going to a newly inferred and predicted picking position to perform picking out. Thereby, the machine learning device 10 can prevent the motion of picking out workpieces 50 by the take-out hand 31 from being stopped, and increase the production efficiency of a production line.

### <Machine Learning Process of Machine Learning Device 10 on Training Phase>

Next, an operation related to a machine learning process of the machine learning device 10 according to the present embodiment on a training phase will be described.

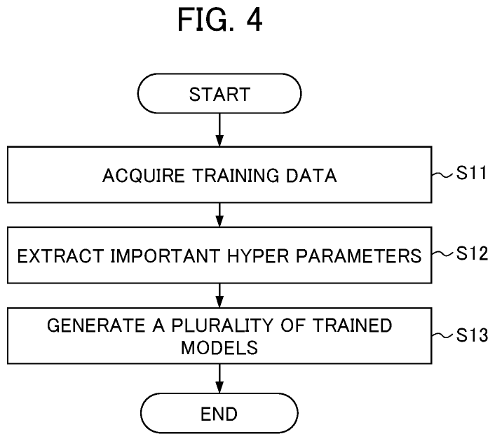

FIG. 4 is a flowchart illustrating the machine learning process of the machine learning device 10 on the training phase.

The flow of FIG. 4 exemplifies batch training. However, the batch training may be replaced with online training or mini-batch training.

At Step S11, the acquisition unit 110 acquires training data from a database 70.

At Step S12, the parameter extraction unit 111 extracts important hyper parameters from among all hyper parameters and the like. Though it is described here that the important parameters are extracted, the present invention is not limited thereto. For example, the total number of hyper parameters is small, the extraction of the important hyper parameters by Step S12 may not be performed.

At Step S13, based on the training data acquired at step S11, the training unit 112 sets a plurality of sets of hyper parameters and the like for a plurality of times, and performs machine learning the plurality of times to generates a plurality of trained models.

### <Inference Calculation Process of the Machine Learning Device 10 on Operational Phase>

Next, an operation related to the inference calculation process of the machine learning device 10 according to the present embodiment on an operational phase will be described.

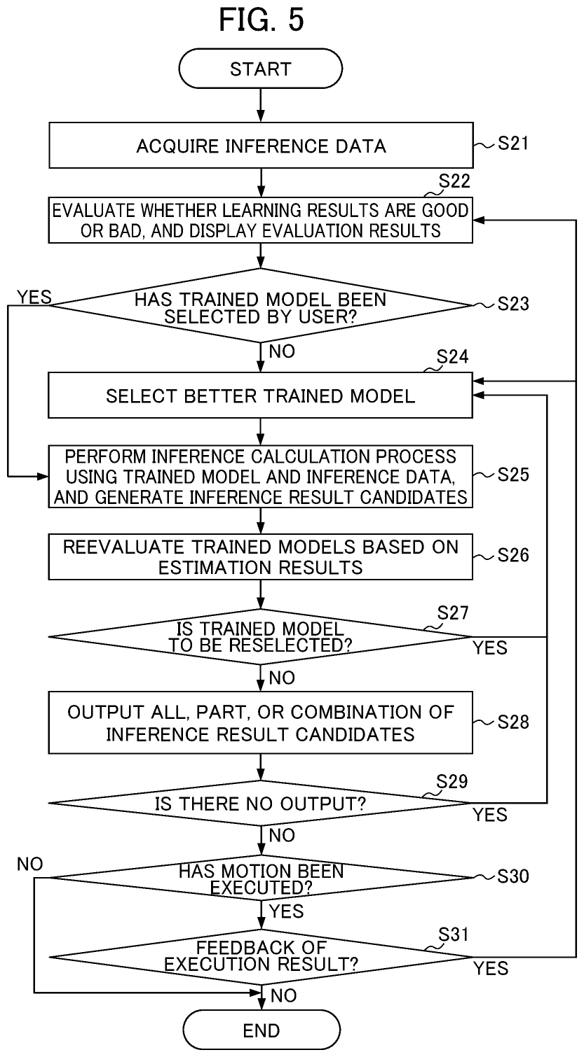

FIG. 5 is a flowchart illustrating the inference calculation process of the machine learning device 10 on the operational phase.

At Step S21, the acquisition unit 110 acquires inference data from the measuring instrument 40.

At Step S22, the model evaluation unit 113 evaluates whether trained results of a plurality of trained models generated by the machine learning process of FIG. 4 by the training unit 112 are good or bad, and displays evaluated results on the display unit (not shown) of the machine learning device 10. The training phase and the operational phase are separately described here, and the plurality of trained models generated may be collectively handed over to the model evaluation unit 113 to be evaluated after all the training phase is completed. The present invention, however, is not limited thereto. For example, evaluation of a trained result of a trained model may be executed online so that, when one trained model is generated, the trained model is immediately handed over to the model evaluation unit 113, and a trained result is evaluated even in the middle of Step S13 of the training phase.

At Step S23, the model selection unit 114 judges whether selection of a trained model has been performed by the user or not, via the input unit (not shown) of the machine learning device 10. If selection of a trained model has been performed by the user, the process transitions to Step S25. On the other hand, if selection of a trained model has been not performed by the user, the process proceeds to Step S24.

At Step S24, the model selection unit 114 selects at least one better trained model from among the plurality of trained models, based on the evaluated results calculated at Step S22.

At Step S25, the inference calculation unit 115 performs the inference calculation process based on the inference data acquired at Step S21 and the trained model selected at Step S23 or S24 to generate inference result candidates.

At Step S26, the model evaluation unit 113 reevaluates whether the plurality of trained models are good or bad, using the inference result candidates generated at Step S25. Though it is described that reevaluation is performed here, the present invention is not limited thereto. For example, Step S26 may be skipped so as to reduce overall calculation processing time. In this case, Step S27 is also skipped, and the process directly transitions to step S28.

At Step S27, the model selection unit 114 judges whether or not to reselect at least one trained model from among the plurality of trained models reevaluated at Step S26. In the case of reselecting a trained model, the process returns to Step S24. On the other hand, in the case of not reselecting a trained model, the process proceeds to Step S28.

At Step S28, the inference decision unit 116 outputs all, a part, or a combination of the inference result candidates calculated at Step S25.

At Step S29, the inference decision unit 116 judges whether there is no outputted inference result candidate at Step 28. If output has not been performed, the process returns to Step S24 to reselect a trained model. On the other hand, if output has been performed, the process proceeds to Step S30.

At Step S30, the machine learning device 10 regards the inference result candidates outputted at Step S28 as picking position information, and judges whether or not the motion execution unit 210 of the robot control device 20 has executed a picking motion based on the picking position information or not. If a picking motion has been executed, the process transitions to Step S31. On the other hand, if a picking motion has not been executed, the inference calculation process is ended.

At Step S31, the machine learning device 10 judges whether feedback of an execution result of the motion of picking out a workpiece 50 by the motion execution unit 210 of the robot control device 20 has been received or not. If the feedback has been received, the process returns to Steps S22 and 24. On the other hand, if the feedback has not been received, the inference calculation process ends.

According to the above, the machine learning device 10 according to an embodiment acquires training data from the database 70, sets a plurality of sets of hyper parameters for a plurality of times, for one set of training data, based on the acquired training data, and performs machine learning the plurality of times to generate a plurality of trained models.

The machine learning device 10 evaluates whether a trained result of each of the generated trained models is good or not, and selects at least one better trained model from among the plurality of trained models based on evaluated results. The machine learning device 10 performs the inference calculation process based on inference data acquired from the measuring instrument 40 and the selected trained model to generate inference result candidates. The machine learning device 10 outputs all, a part, or a combination of the generated inference result candidates.

Thereby, it is possible for the machine learning device 10 to, by generating and comprehensively utilizing a plurality of biased trained models, reduce time and effort required to collect training data for use for training, and obtain a good performance even with a small amount of training data. That is, the time and effort required to collect training data for use for training is reduced, and a good performance is obtained even with a small amount of training data.

Further, even when, because the number of hyper parameters requiring adjustment is too large, it is not possible to generate a good trained model no matter how adjustment is performed, the machine learning device 10 can show an overall good performance by combining a plurality of biased inference result candidates generated by utilizing a plurality of biased trained models or by selecting at least one good trained model according to an actual situation.

Further, the machine learning device 10 can solve the problems of not detecting and leaving behind a workpiece in image recognition and realize a high production efficiency.

An embodiment has been described above. The machine learning device 10, however, is not limited to the above embodiment, and modifications, improvements and the like in a range capable of achieving the object are included.

### Modification Example 1

In the one embodiment described above, the machine learning device 10 is exemplified as a device different from the robot control device 20. However, a configuration is also possible in which the robot control device 20 is provided with a part or all of the functions of the machine learning device 10.

Or alternatively, for example, a server may be provided with a part or all of the acquisition unit 110, the parameter extraction unit 111, the training unit 112, the model evaluation unit 113, the model selection unit 114, the inference calculation unit 115, and the inference decision unit 116 of the machine learning device 10. Further, each function of the machine learning device 10 may be realized by utilizing a virtual server function and the like on a cloud.

Furthermore, the machine learning device 10 may be a distributed processing system in which the functions of the machine learning device 10 are appropriately distributed to a plurality of servers.

### Modification Example 2

Further, for example, the machine learning device 10 separately executes the machine learning process and the inference calculation process in the above embodiment. The present invention, however, is not limited thereto. For example, the machine learning device 10 may be adapted to execute the inference calculation process while executing the machine learning process by online training.

Each of the function included in the machine learning device 10 in the one embodiment can be realized by hardware, software, or a combination thereof. Here, being realized by software means being realized by a computer reading and executing a program.

The program can be supplied to the computer by being stored in any of various types of non-transitory computer-readable media. The non-transitory computer-readable media include various types of tangible storage media. Examples of the non-transitory computer-readable media include a magnetic recording medium (for example, a flexible disk, a magnetic tape, and a hard disk drive), a magneto-optical recording medium (for example, a magneto-optical disk), a CD-ROM (read-only memory), a CD-R, a CD-R/W, a semiconductor memory (for example, a mask ROM, a PROM (programmable ROM), an EPROM (Erasable PROM), a flash ROM, and a RAM). The program may be supplied to the computer by any of various types of transitory computer-readable media. Examples of the transitory computer-readable media include an electrical signal, an optical signal, and an electromagnetic wave. The transitory computer-readable media can supply the program to the computer via a wired communication path such as an electrical wire and an optical fiber, or a wireless communication path.

Steps describing the program recorded in a recording medium include not only processes that are performed in chronological order but also processes that are not necessarily chronologically performed but are executed in parallel or individually.

In other words, the machine learning device and machine learning method of the present disclosure can take various embodiments having the following configurations.

(1) A machine learning device 10 of the present disclosure is a machine learning device including: an acquisition unit 110 configured to acquire training data and inference data for use for machine learning; a training unit 112 configured to perform machine learning based on the training data and a plurality of sets of training parameters, and generate a plurality of trained models; a model evaluation unit 113 configured to evaluate whether trained results of the plurality of trained models are good or bad and display evaluated results; a model selection unit 114 capable of accepting selection of a trained model; an inference calculation unit 115 configured to perform an inference calculation process based on at least a part of the plurality of trained models, and the inference data, generate inference result candidates; and an inference decision unit 116 configured to output all, or a part, or a combination of the inference result candidates.

According to the machine learning device 10, it is possible to reduce time and effort required to collect training data for use for training, and obtain a good performance with a small amount of training data.

(2) In the machine learning device 10 according to (1), the model selection unit 114 may accept a trained model selected by a user based on the evaluated results displayed by the model evaluation unit 113.

By doing so, even if there is an error in evaluated results calculated by a computer, the machine learning device 10 can perform the inference calculation process according to an optimal trained model selected according to an actual situation at a site recognized by the user. Furthermore, it is also possible to, by feeding back a result of selection by the user to perform training, and performing correction of calculation errors of the computer and improvement of a machine learning algorithm, increase the prediction accuracy of the machine learning device 10.

(3) In the machine learning device 10 according to (1), the model selection unit 114 may automatically select a trained model based on the evaluated results by the model evaluation unit 113 without depending on intervention of the user.

By doing so, the machine learning device 10 can autonomously select an optimal trained model according to rules obtained by the machine learning device 10 performing training itself in an unmanned environment, and perform the inference calculation process using the optimal trained model.

(4) The machine learning device 10 according to any of (1) to (3) may further include a parameter extraction unit 111, and the parameter extraction unit 111 may extract important hyper parameters from among the plurality of hyper parameters; and the training unit 112 may perform machine learning based on the extracted hyper parameters, and generate the plurality of trained models.

By doing so, the machine learning device 10 can reduce time required to adjust hyper parameters and increase the efficiency of training.

(5) In the machine learning device 10 according to any of (1) to (4), the model evaluation unit 113 may evaluate whether the trained models are good or bad, based on the inference result candidates generated by the inference calculation unit 115.

By doing so, the machine learning device 10 can correctly evaluate the actual power of the trained models, based on actual inference data that has not been used for training.

(6) In the machine learning device 10 according to (5), based on the evaluated results by the model evaluation unit 113 that are based on the inference result candidates generated by the inference calculation unit 115, a trained model that has obtained better inference result candidates may be selected.

By doing so, the machine learning device 10 can select an optimal trained model that has obtained the best performance.

(7) In the machine learning device 10 according to any of (1) to (6), the inference calculation unit 115 may perform the inference calculation process based on trained models evaluated as good by the model evaluation unit 113, and generate the inference result candidates.

By doing so, since good inference result candidates cannot be obtained even if the inference calculation process is performed using a “bad” trained model generated without training being performed well, the machine learning device 10 can eliminate such useless inference calculation processing time and increase the efficiency of the inference calculation process.

(8) In the machine learning device 10 according to any of (1) to (7), the model selection unit 114 may select the trained model based on the inference result candidates generated by the inference calculation unit 115.

By doing so, the machine learning device 10 can, by selecting a trained model that could predict more picking position candidates for one inference image captured by one photographing, pick out more workpieces by one picking motion, and increase the efficiency of picking out workpieces.

(9) In the machine learning device 10 according to any of (1) to (8), when there is no output from the inference decision unit 116, the model selection unit 114 may newly select one or more trained models from among the plurality of trained models, the inference calculation unit 115 may perform the inference calculation process based on the one or more trained models newly selected, and generate one or more new inference result candidates, and the inference decision unit 116 may output all, or a part, or a combination of the new inference result candidates.

By doing so, even when there is no picking position outputted as an inference result, the machine learning device 10 can, by newly selecting a trained model and goes to a newly inferred and predicted picking position to perform picking out, prevent operation of the motion of picking out workpieces 50 by the take-out hand 31 from being stopped, realize continuous picking motions, and increase the production efficiency of a production line.

(10) In the machine learning device 10 according to any of (1) to (9), the training unit 112 may perform machine learning based on a plurality of sets of the training data.

By doing so, the machine learning device 10 can perform training utilizing a great variety of pieces of training data, obtain such a trained model with a good robustness that can infer various situations well, and shows an overall good performance.

(11) In the machine learning device 10 according to any of (1) to (10), the acquisition unit 110 may acquire, image data of an area where a plurality of workpieces 50 are present, as the training data and the inference data, and the training data may include teaching data of at least one characteristic of the workpieces 50 appeared on the image data.

By doing so, the machine learning device 10 can generate, by machine learning, such a trained model that can output a predicted value close to teaching data and can identify characteristics similar to characteristics included in the teaching data in various inference image data.

(12) In the machine learning device 10 according to any of (1) to (11), the acquisition unit 110 may acquire, three-dimensional measurement data of an area where a plurality of workpieces 50 are present, as the training data and the inference data, and the training data may include teaching data of at least one characteristic of the workpieces 50 appeared in the three-dimensional measurement data.

By doing so, the machine learning device 10 can generate, by machine learning, such a trained model that can output a predicted value close to teaching data and can identify characteristics similar to characteristics included in the teaching data in various inference three-dimensional measurement data.

(13) In the machine learning device 10 according to (11) or (12), the training unit 112 may perform machine learning based on the training data, and the inference calculation unit 115 may generate inference result candidates including information about the at least one characteristic of the workpieces 50.

By doing so, the machine learning device 10 can obtain an overall good performance by making good use of a plurality of trained models capable of identifying characteristics similar to characteristics included in teaching data on various inference data.

(14) In the machine learning device 10 according to any of (1) to (10), the acquisition unit 110 may acquire, image data of an area where a plurality of workpieces 50 are present, as the training data and the inference data, and the training data may include teaching data of at least one picking position for the workpieces 50 appeared on the image data.

By doing so, the machine learning device 10 can generate, by machine learning, such a trained model that can output a predicted value close to teaching data and can estimate a position similar to a picking position included in the teaching data in various inference image data.

(15) In the machine learning device 10 according to any of (1) to (10), and (14), the acquisition unit 110 may acquire, three-dimensional measurement data of the area where the plurality of workpieces 50 are present, as the training data and the inference data, and the training data may include teaching data of at least one picking position for the workpieces 50 appeared in the three-dimensional measurement data.

By doing so, the machine learning device 10 can generate, by machine learning, such a trained model that can output a predicted value close to teaching data and can estimate a position similar to a picking position included in the teaching data on various inference three-dimensional data.

(16) In the machine learning device 10 according to (14) or (15), the training unit 112 may perform machine learning based on the training data, and the inference calculation unit 115 may generate inference result candidates including information about the at least one picking position for the workpieces 50.

By doing so, the machine learning device 10 can obtain an overall good performance by making good use of a plurality of trained models capable of estimating a position similar to a picking position included in teaching data on various inference data.

(17) In the machine learning device 10 according to (16), the model evaluation unit 113 may receive, from a robot control device 20 including a motion execution unit 210 causing a robot 30 with a hand 31 for picking out the workpieces 50 to execute motions of picking out the workpieces 50 by the hand 31, execution results of the picking motions by the motion execution unit 210 based on results of inference of the at least one picking position for the workpieces 50 outputted by the machine learning device 10, and evaluate whether the trained results of the plurality of trained models are good or bad based on the execution results of the picking motions.

By doing so, the machine learning device 10 can give a high evaluation value to a trained model that has predicted inference result candidates with high success rates of picking out workpieces 50.

(18) In the machine learning device 10 according to (16) or (17), the model selection unit 114 may receive, from a robot control device 20 including a motion execution unit 210 controlling a robot 30 with a hand 31 for picking out the workpieces 50 to execute motions of picking out the workpieces 50 by the hand 31, execution results of the picking motions by the motion execution unit 210 based on results of inference of the at least one picking position for the workpieces 50 outputted by the machine learning device 10, and select a trained model based on the execution results of the picking motions.

By doing so, the machine learning device 10 can select a trained model that predicts inference result candidates with high success rates of picking out workpieces 50.

(19) A machine learning method of the present disclosure is a machine learning method executed by a computer, the machine learning method including: an acquisition step of acquiring training data and inference data for use for machine learning; a training step of performing machine learning based on the training data and a plurality of sets of training parameters, and generating a plurality of trained models; a model evaluation step of evaluating whether trained results of the plurality of trained models are good or bad and displaying evaluated results; a model selection step of enabling acceptance of selection of a trained model; an inference calculation step of performing an inference calculation process based on at least a part of the plurality of trained models, and the inference data, generating inference result candidates; and an inference decision step of outputting all, or a part, or a combination of the inference result candidates.

According to the machine learning method, effects similar to those of (1) can be obtained.

### EXPLANATION OF REFERENCE NUMERALS

1: Robot system
10: Machine learning device
11: Control unit
110: Acquisition unit
111: Parameter extraction unit
112: Training unit
113: Model evaluation unit
114: Model selection unit
115: Inference calculation unit
116: Inference decision unit
20: Robot control device
21: Control unit
210: Motion execution unit
30: Robot
40: Measuring instrument
50: Workpiece
60: Container
70: Database

1. A machine learning device comprising:
an acquisition unit configured to acquire training data and inference data for use for machine learning;
a training unit configured to perform machine learning based on the training data and a plurality of sets of training parameters, and generate a plurality of trained models;
a model evaluation unit configured to evaluate whether trained results of the plurality of trained models are good or bad and display evaluated results;
a model selection unit capable of accepting selection of a trained model;
an inference calculation unit configured to perform an inference calculation process based on at least a part of the plurality of trained models, and the inference data, generate inference result candidates; and
an inference decision unit configured to output all, or a part, or a combination of the inference result candidates.

2. The machine learning device according to claim 1, wherein
the model selection unit accepts a trained model selected by a user based on the evaluated results displayed by the model evaluation unit.

3. The machine learning device according to claim 1, wherein
the model selection unit selects a trained model based on the evaluated results by the model evaluation unit.

4. The machine learning device according to claim 1, further comprising a parameter extraction unit, wherein
the parameter extraction unit extracts important training parameters from among the plurality of training parameters, and
the training unit performs machine learning based on the extracted training parameters, and generates the plurality of trained models.

5. The machine learning device according to claim 1, wherein
the model evaluation unit evaluates whether the trained models are good or bad, based on the inference result candidates generated by the inference calculation unit.

6. The machine learning device according to claim 5, wherein
the model selection unit selects a trained model, based on the evaluated results by the model evaluation unit, that using the inference result candidates generated by the inference calculation unit.

7. The machine learning device according to claim 1, wherein
the inference calculation unit performs the inference calculation process based on trained models evaluated as good by the model evaluation unit, and generates the inference result candidates.

8. The machine learning device according to claim 1, wherein
the model selection unit selects the trained model based on the inference result candidates generated by the inference calculation unit.

9. The machine learning device according to claim 1, wherein
when there is no output from the inference decision unit, the model selection unit newly selects one or more trained models from among the plurality of trained models,
the inference calculation unit performs the inference calculation process based on the one or more trained models newly selected, and generates one or more new inference result candidates, and
the inference decision unit outputs all, or a part, or a combination of the new inference result candidates.

10. The machine learning device according to claim 1, wherein
the training unit performs machine learning based on a plurality of sets of the training data.

11. The machine learning device according to claim 1, wherein
the acquisition unit acquires, image data of an area where a plurality of workpieces are present, as the training data and the inference data, and
the training data includes teaching data of at least one characteristic of the workpieces appeared on the image data.

12. The machine learning device according to claim 1, wherein
the acquisition unit acquires, three-dimensional measurement data of an area where a plurality of workpieces are present, as the training data and the inference data; and
the training data includes teaching data of at least one characteristic of the workpieces appeared in the three-dimensional measurement data.

13. The machine learning device according to claim 11, wherein
the training unit performs machine learning based on the training data, and
the inference calculation unit generates inference result candidates including information about the at least one characteristic of the workpieces.

14. The machine learning device according to claim 1, wherein
the acquisition unit acquires, image data of an area where a plurality of workpieces are present, as the training data and the inference data, and
the training data includes teaching data of at least one picking position for the workpieces appeared on the image data.

15. The machine learning device according to claim 1, wherein
the acquisition unit acquires, three-dimensional measurement data of an area where a plurality of workpieces are present, as the training data and the inference data, and
the training data includes teaching data of at least one picking position for the workpieces appeared in the three-dimensional measurement data.

16. The machine learning device according to claim 14, wherein
the training unit performs machine learning based on the training data, and
the inference calculation unit generates inference result candidates including information about the at least one picking position for the workpieces.

17. The machine learning device according to claim 16, wherein
the model evaluation unit receives, from a control device comprising a motion execution unit causing a robot with a hand for picking out the workpieces to execute motions of picking out the workpieces by the hand, execution results of the picking motions by the motion execution unit based on results of inference of the at least one picking position for the workpieces outputted by the machine learning device, and evaluates whether the trained results of the plurality of trained models are good or bad based on the execution results of the picking motions.

18. The machine learning device according to claim 16, wherein
the model selection unit receives, from a control device comprising a motion execution unit controlling a robot with a hand for picking out the workpieces to execute motions of picking out the workpieces by the hand, execution results of the picking motions by the motion execution unit based on results of inference of the at least one picking position for the workpieces outputted by the machine learning device, and selects a trained model based on the execution results of the picking motions.

19. A machine learning method executed by a computer, the machine learning method comprising:
an acquisition step of acquiring training data and inference data for use for machine learning;
a training step of performing machine learning based on the training data and a plurality of sets of training parameters, and generating a plurality of trained models;
a model evaluation step of evaluating whether trained results of the plurality of trained models are good or bad and displaying evaluated results;
a model selection step of enabling acceptance of selection of a trained model;
an inference calculation step of performing an inference calculation process based on at least a part of the plurality of trained models, and the inference data, generating inference result candidates; and
an inference decision step of outputting all, or a part, or a combination of the inference result candidates.
